(19) United States
(12) Patent Application Publication
(10) Pub. No.: US 2015/0092825 A1
(43) Pub. Date: Apr. 2, 2015

(54) SELF-TEST USING INTERNAL FEEDBACK FOR TRANSMIT SIGNAL QUALITY ESTIMATION

(71) Applicant: QUALCOMM Incorporated, San Diego, CA (US)

(72) Inventors: Li GAO, San Diego, CA (US); Abhishek Kumar AGRAWAL, Fremont, CA (US); Douglas GROVER, San Diego, CA (US); Chalin Chac LEE, San Diego, CA (US); Jarir Muhammad FADLULLAH, San Diego, CA (US); Dongbo ZHANG, San Diego, CA (US); Rema VAIDYANATHAN, San Diego, CA (US)

(21) Appl. No.: 14/303,594

(22) Filed: Jun. 12, 2014

Related U.S. Application Data
(60) Provisional application No. 61/883,824, filed on Sep. 27, 2013.

(51) Int. Cl. H04L 1/24

(52) U.S. Cl. CPC H04L 1/243
USPC 375/224

(57) ABSTRACT

A method, an apparatus, and a computer program product for wireless communication are provided. The apparatus correlates the feedback signal to a reference transmit signal to correct time misalignments between the transmit chain and the feedback loop, wherein the reference transmit signal is generated in digital domain at an input to a transmit chain and estimates a transmit signal quality value based on the correlation.

### CLAIM OF PRIORITY UNDER 35 U.S.C. §119

The present Application for Patent claims priority to Provisional Application No. 61/883,824, entitled “INTERNAL FEEDBACK BASED EVM MEASUREMENT” filed Sep. 27, 2013, and assigned to the assignee hereof and hereby expressly incorporated by reference herein.

### BACKGROUND

1. Field

The present disclosure relates generally to communication systems, and more particularly, to a self-test of a wireless user equipment (UE).

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems. These multiple access technologies have been adopted in various telecommunication standards to provide a common protocol that enables different wireless devices to communicate on a municipal, national, regional, and even global level.

A user equipment (UE) has a transmitter and a receiver used for sending and receiving communication signals. To transmit data, a transmit chain of modules performs various transformations and modulations in both digital and analog domains before the signal is sent to the antenna for transmission over the wireless medium. Along the way, these various modules along with the transmit power amplifier introduce distortions to the original transmit signal. Other sources of error on the transmit chain that may be introduced include bad software, calibration error, and setting errors. In order to test the quality of the transmission signal for a particular UE, which accounts for the distortions introduced by the transmit chain, the UE is tested in the factory using test equipment that provides a reference signal as the benchmark for comparison and error assessment. Examples of such error measurements include an error vector magnitude (EVM) and an adjacent channel leakage ratio (ACLR). To determine EVM for example, a magnitude and phase error between ideal symbol location and measured symbol location is obtained after decimating the recovered waveform at the de-modulator output of the test box. Continuous monitoring of transmit EVM and factory testing for EVM performance requirements requires measurement of EVM of a transmitter while utilizing external instruments on a test bench. When testing a large volume of UE units, this is time consuming, costly and labor intensive.

### SUMMARY

In an aspect of the disclosure, a method, a computer program product, and an apparatus are provided. The method comprises performing a self-test within a user equipment (UE) to determine transmit signal quality measurement and transmitter reconfiguration. The UE generates a transmit signal, retrieves the transmit signal in digital domain from the transmit chain and stores the transmit signal as a reference signal. The transmit signal is sent along the transmit chain, through a coupling at the antenna, and retrieved as a feedback signal in digital domain via a feedback loop. A processor correlates the stored reference signal to the feedback signal to correct time misalignment between the transmit chain and the feedback loop. The processor calculates a transmit signal quality value based on the correlation and spectrum analysis. As an example, the transmit signal quality value may be an error vector magnitude or an adjacent channel leakage ratio.

### BRIEF DESCRIPTION OF THE DRAWINGS

FIG. 1 is a block diagram of a user equipment configured to produce a transmit reference signal and internally retrieve a feedback signal.

FIG. 2 is a block diagram showing the analog transceiver and power amplifier/duplexer of FIG. 1 in greater detail.

FIG. 3 is a flow chart of a method for self-test of a user equipment.

FIG. 4 is a flow chart of a method showing FIG. 3 steps in greater detail.

FIG. 5 is a flow chart of a self-test method performed by an exemplary user equipment.

FIG. 6 is a conceptual data flow diagram illustrating the data flow between different modules/means/components in an exemplary apparatus.

FIG. 7 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of a user equipment (UE) used in telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

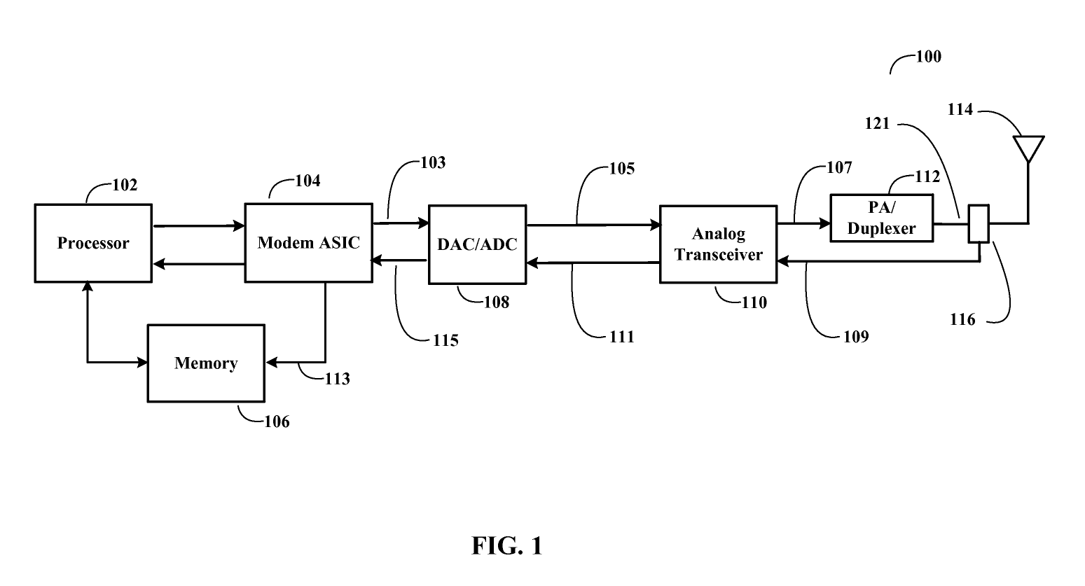

FIG. 1 is a block diagram illustrating aspects of a UE 100. Examples of a UE 100 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 100 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

As shown in FIG. 1, the UE 100 may comprise a processor 102, a modem application specific integrated circuit (ASIC) 104, a memory 106, a digital-to-analog converter (DAC)/analog-to digital converter (ADC) 108, an analog transceiver 110, a power amplifier (PA)/duplexer 112 connected to the antenna 114, and a coupler 116. A transmit chain is formed by signal paths 103, 105, and 107 between the modem ASIC 104, the DAC/ADC 108, the analog transceiver 110 and the PA/duplexer 112. A feedback chain is formed by the signal paths 109, 111 and 115 between the coupler 116, the analog transceiver 110, the DAC/ADC 108 and the modem ASIC 104. During operation of a self-test for transmit signal quality, the modem ASIC 104 digitally encodes data and generates a transmit signal as a digital baseband. The transmit signal may be stored in memory 106 as a reference transmit signal 113. After conversion to an analog signal 105 by the DAC/ADC 108, the analog transceiver 110 may tune to an RF carrier frequency at band X and channel Y and may upconvert the analog signal on the RF carrier frequency. The modulated signal 107 may be processed by the PA/duplexer 112 (i.e., power amplification and forward flow in the transmit direction of the duplexer) to replicate a transmit signal 121 that would be sent to the antenna 114 for transmission as an RF signal in a wireless communication under normal operation. However, the self-test procedure for the UE 100 does not rely on actual transmission over the antenna. Instead, the feedback chain may be configured to internally retrieve the transmit signal 121 through an RF coupler 116 for comparison to the reference signal 113. The coupler 116 retrieves the transmit signal 121 and sends it as a feedback signal 109 back through the feedback chain. After demodulating the feedback signal, the analog transceiver 110 sends the feedback signal 111 to the DAC/ADC 108, which converts the signal to a digital feedback sample 115. The modem ASIC receives the feedback sample 115 and stores it in memory 106. The processor 102 may correlate the stored reference transmit signal 103 with the stored feedback sample 115 to correct for time misalignment between the transmit chain and the feedback loop. From the correlation, the processor calculates a transmit signal quality value, such as an EVM or an ACLR.

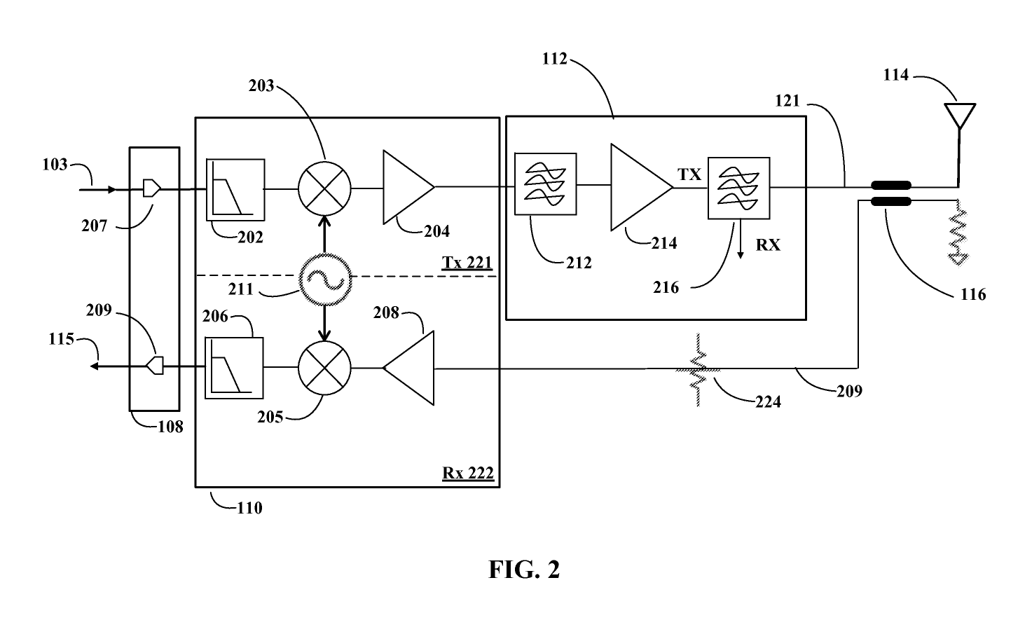

FIG. 2 is a block diagram illustrating the transmit chain and the feedback chain in greater detail. The ADC/DAC 108 includes a DAC 207 and an ADC 209. The digital transmit data 103 is converted by the DAC 207, and the digital feedback signal 115 is produced by the ADC 209. The analog transceiver 110 includes a transmitter 221 and a feedback receiver 222, which share a local oscillator 211. The transmitter 221 performs operations for radio frequency (RF) transmission converting between baseband I/Q data and RF signals, and may comprise a low pass filter 202, an upconverter 203, and a driver amplifier 204 on the transmit chain. The upconverter 203 is set to a band X and channel Y for the transmit signal and driven by the local oscillator 211 and drive amplifier 204. Next, the RF signal is processed by a bandpass filter 212, a power amplifier 214, and a duplexer 216. The feedback receiver 222 may include a low pass filter 206, the downconverter 205, and a low noise amplifier 208. The feedback signal 209 is amplified by the low noise amplifier 208, downconverted by the downconverter 205, which uses the local oscillator 211. The downconverted feedback signal is filtered by the filter 206, and converted to the digital baseband by the DAC 209. The coupler 116 is arranged to retrieve and return the actual transmit signal 221 as a feedback signal 209. An external pad 224 provides adjustment to the feedback signal to optimize measurements, such as for example, when the transmit signal power is marginally high so that a saturated feedback signal is avoided. Alternatively, low pass filters 202 and 206 may be bandpass filters.

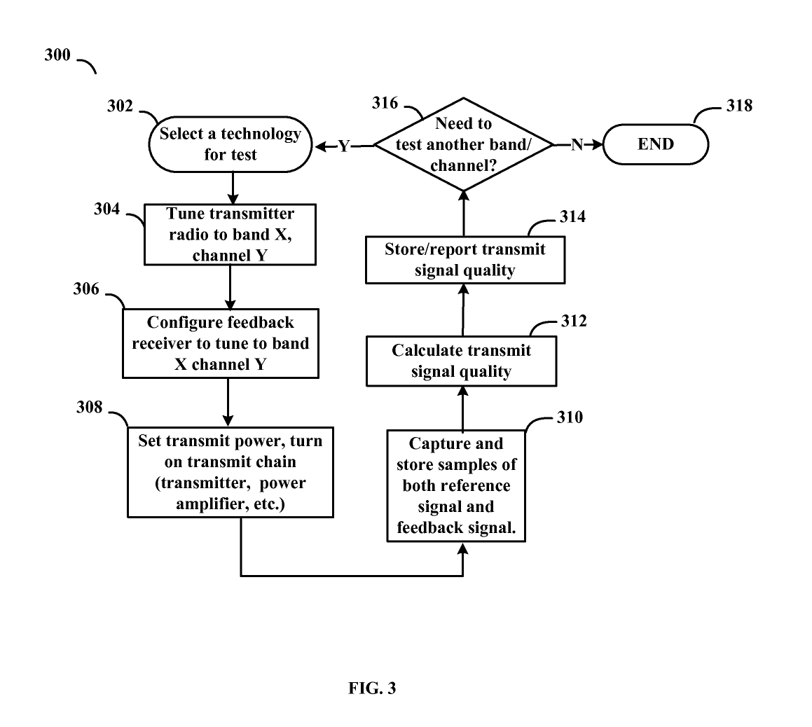

FIG. 3 is a flow diagram that illustrates an example method 300 performed by a UE 100 for determining a quality estimation value of its transmit signal. At 302, the processor 102 selects a wireless technology (e.g., LTE, LTE-A, HSPA+, etc.) to be tested for the transmit signal quality. Based on the technology selection, the radio of the transmitter 221 is tuned to a radio band X and channel Y at 304. The radio of the feedback chain receiver 222 is also tuned to radio band X and channel Y at 306. The transmit power is set for power amplifier 214 and the transmit chain is energized at 308. A sample of the reference signal 103 and a sample of the feedback signal 115 are captured and stored in the memory 106 at 310. The processor 102 performs the correlation and comparison between the reference signal and the feedback signal and calculates the transmit signal quality at 312. The transmit signal quality value is stored in memory 104 at 314. Alternatively, the transmit signal quality value may be reported by the UE 100 using reporting means, such as the transceiver 110 and antenna 114, or as a direct display on a display screen unit of the UE 100 (not shown). At 316, the processor 102 may determine if another band or channel needs to be tested, and repeats the above procedure for any further tests. Otherwise, the self-test is ended at 318. The aspects illustrated in FIG. 3 may be preceded by the following additional steps. To initiate the self-test process, the apparatus may be powered up. The processor 102 may load embedded software with execution instructions, load calibration data, and check whether calibration data is valid prior to proceeding to block 302. If the calibration data is determined to be invalid, the error may be reported and the self-test process is aborted.

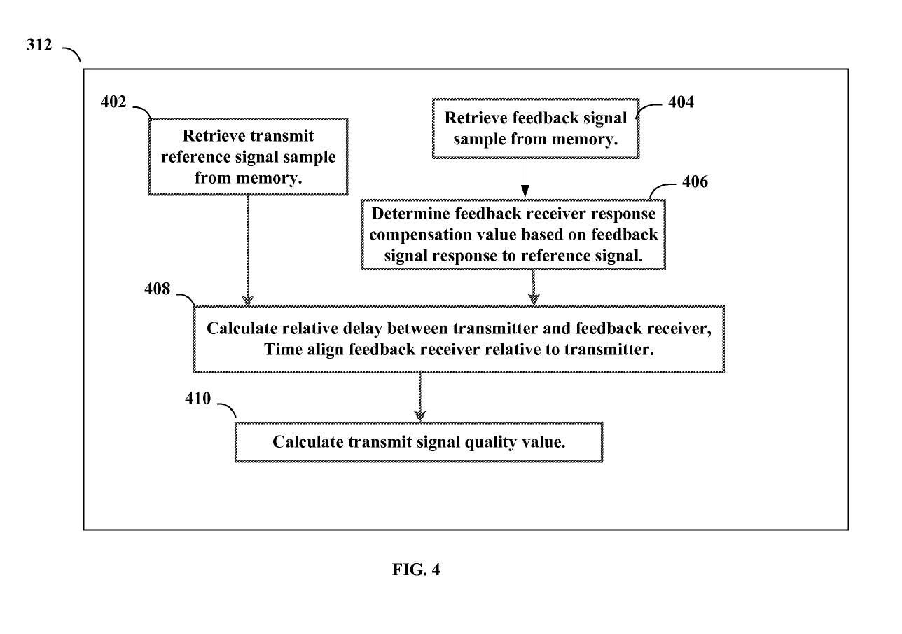

FIG. 4 is a flow diagram that illustrates an example of steps of method 300 in further detail. With respect to calculating the transmit signal quality value (at 312), the transmitter reference sample is retrieved from memory (at 402), the feedback signal sample is retrieved from memory (at 404). A compensation value for the feedback chain is determined based on a feedback receiver response (at 406). At 408, the processor 102 correlates and calculates a relative delay between the transmit chain and the feedback chain based on the retrieved transmit reference signal sample, the feedback signal sample, and the feedback receiver response compensation value. The processor 102 time aligns the feedback chain with the transmit chain based on the relative delay. At 410, the processor calculates the transmit signal quality value, such as an EVM or ACLR, using the time aligned feedback signal.

The processor 102 may calculate an EVM according to at least one of the following approaches. In a first aspect, the processor 102 may calculate the error vector between transmissions and may receive a modulated waveform without demodulation. In a second aspect, the processor may demodulate a received signal and obtain a signal constellation to calculate an EVM.

The processor 102 may also calculate an ACLR according to at least one of the following approaches. In a first aspect, the processor 102 may perform a power spectrum analysis, and may evaluate emission spectrum at a frequency offset and a frequency range according to standard specifications. In a second aspect, the processor 102 may filter the time domain signal waveform with a designed filter so that only a frequency range of interest is covered by a band pass filter. At various tuning filter outputs, filter output power may then represent either main signal power or the emission power, which can be used to calculate the ACLR.

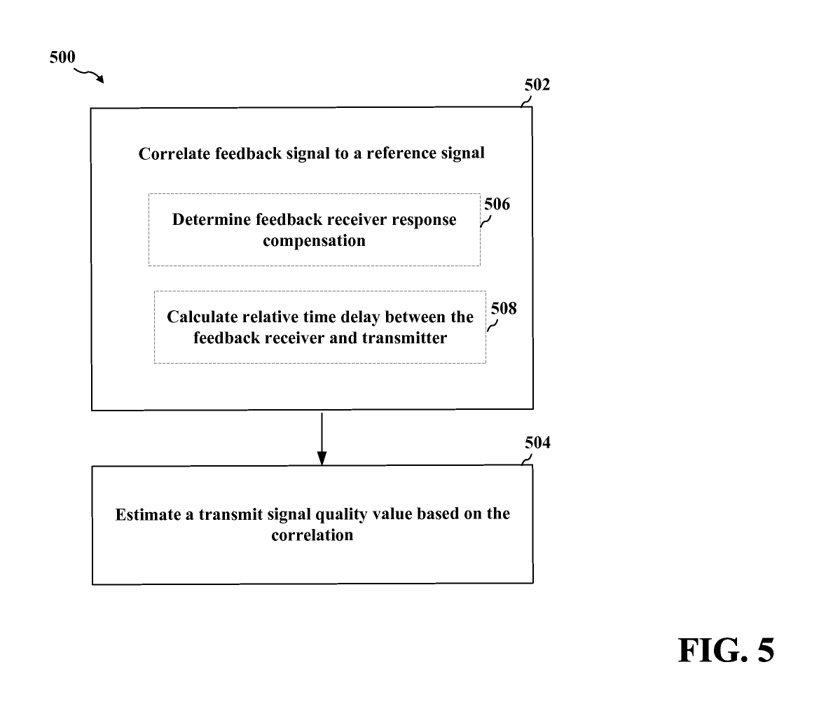

FIG. 5 is a flow chart of a method 500 of self-testing a user equipment, e.g., to determine transmit signal quality based on a feedback signal sample retrieved at an output of a transmit chain. At 502, the feedback signal is correlated to a reference transmit signal to correct time misalignments between the transmit chain and the feedback loop. The reference transmit signal is generated, e.g., in digital domain at an input to a transmit chain. At 504, a transmit signal quality value is estimated based on the correlation. The transmit signal quality value may comprise, e.g., an EVM or an ACLR. The correlation at 502 may further include determining a feedback receiver response compensation based on feedback signal response to the reference transmit signal, as illustrated at 506. The correlation at 502 may also include calculating a relative time delay between the feedback receiver and a transmitter of the transmit chain, as illustrated at 508. Optional aspects in FIG. 5 are illustrated having a dashed line.

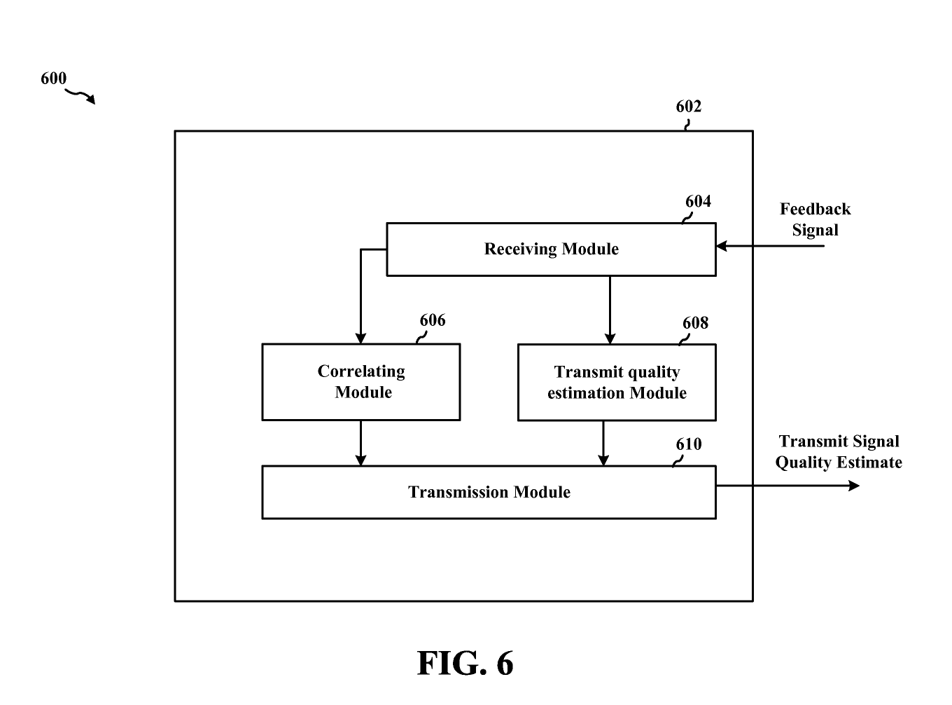

FIG. 6 is a conceptual data flow diagram 600 illustrating the data flow between different modules/means/components in an example apparatus 602. The apparatus may be a UE. The apparatus includes a module 604 that receives a feedback signal sample from the feedback chain. The apparatus includes a module 606 that obtains the feedback signal from the receiving module 604 and correlates the feedback signal to a reference transmit signal to correct time misalignments between the transmit chain and the feedback loop. The reference transmit signal is generated in digital domain at an input to a transmit chain. The apparatus includes a module 608 that estimates a transmit signal quality value based on the correlation. The apparatus includes a transmission module that received the transmit signal quality value from module 608. The transmission module 610 saves and reports the transmit signal quality estimation. The correlating module 606 may determine a feedback receiver response compensation based on feedback signal response to the reference transmit signal. The correlating module 606 may calculate a relative time delay between the feedback receiver and a transmitter of the transmit chain.

The apparatus may include additional modules that perform each of the steps of the algorithm in the aforementioned flow charts of FIGS. 3-5. As such, each step in the aforementioned flow charts of FIGS. 3-5 may be performed by a module shown in FIG. 6, and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

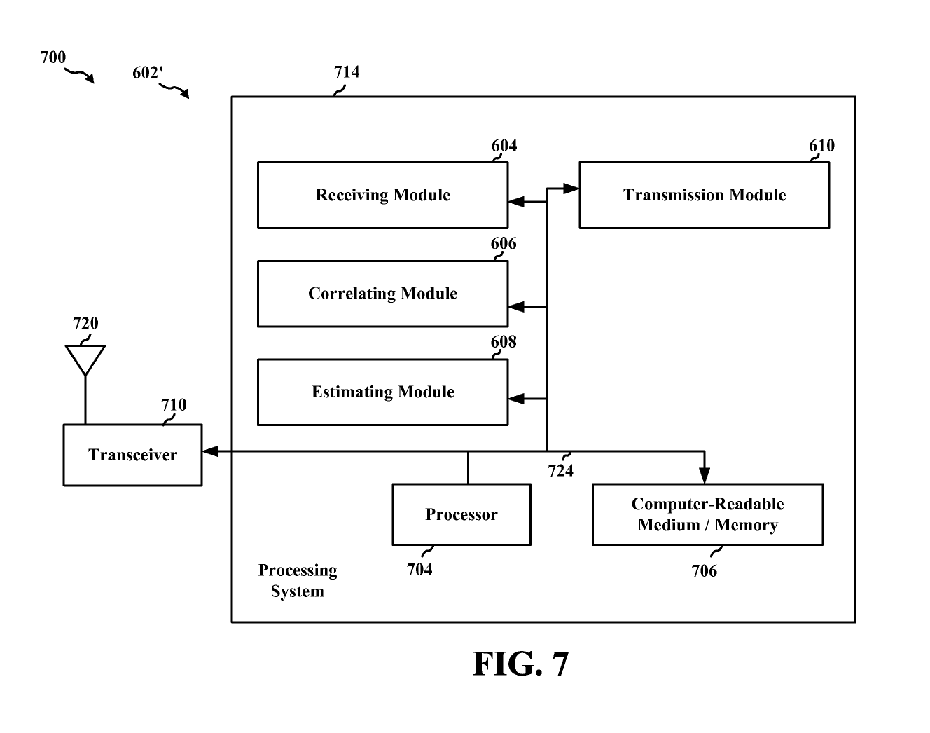

FIG. 7 is a diagram 700 illustrating an example of a hardware implementation for an apparatus 602′ employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 704, the modules 604, 606, 608, 610 and the computer-readable medium/memory 706. The bus 724 may also link various other circuits such as timing sources, peripherals, voltage regulators, and power management circuits, which are well known in the art, and therefore, will not be described any further.

The processing system 714 may be coupled to a transceiver 710. The transceiver 710 is coupled to one or more antennas 720. The transceiver 710 provides a means for communicating with various other apparatus over a transmission medium. During the self-test method of the present application, the transceiver 710 receives a feedback signal from the coupling at the one or more antennas 720, extracts information from the received signal, and provides the extracted information to the processing system 714, specifically the receiving module 604. In addition, the transceiver 710 receives information from the processing system 714, specifically the transmission module 610, and based on the received information, generates a signal to be applied to the one or more antennas 720. The processing system 714 includes a processor 704 coupled to a computer-readable medium/memory 706. The processor 704 is responsible for general processing, including the execution of software stored on the computer-readable medium/memory 706. The software, when executed by the processor 704, causes the processing system 714 to perform the various functions described supra for any particular apparatus. The computer-readable medium/memory 706 may also be used for storing data that is manipulated by the processor 704 when executing software. The processing system further includes at least one of the modules 604, 606, 608, and 610. The modules may be software modules running in the processor 704, resident/stored in the computer readable medium/memory 706, one or more hardware modules coupled to the processor 704, or some combination thereof.

In one configuration, the apparatus 602/602′ for self-test includes means for correlating the feedback signal to a reference transmit signal to correct time misalignments between the transmit chain and the feedback loop, wherein the reference transmit signal is generated in digital domain at an input to a transmit chain. The apparatus 602/602′ for self test also includes means for estimating a transmit signal quality value based on the correlation. The aforementioned means may be one or more of the aforementioned modules of the apparatus 602 and/or the processing system 714 of the apparatus 602′ configured to perform the functions recited by the aforementioned means. As described supra, the processing system 714 may include a transmit processor, a receive processor, and a controller/processor. As such, in one configuration, the aforementioned means may be the transmit processor, the receive processor, and the controller/processor configured to perform the functions recited by the aforementioned means.

It is understood that the specific order or hierarchy of steps in the processes/flow charts disclosed is an illustration of example approaches. Based upon design preferences, it is understood that the specific order or hierarchy of steps in the processes/flow charts may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for self-testing a user equipment to determine transmit signal quality based on a feedback signal sample retrieved at output of a transmit chain, comprising:
correlating the feedback signal to a reference transmit signal to correct time misalignments between the transmit chain and the feedback loop, wherein the reference transmit signal is generated in digital domain at an input to a transmit chain; and
estimating a transmit signal quality value based on the correlation.

2. The method of claim 1, wherein the correlating further comprises determining a feedback receiver response compensation based on feedback signal response to the reference transmit signal.

3. The method of claim 2, wherein the correlating further comprises calculating a relative time delay between the feedback receiver and a transmitter of the transmit chain.

4. The method of claim 1, wherein the transmit signal quality value comprises an error vector magnitude (EVM).

5. The method of claim 1, wherein the transmit signal quality value comprises an adjacent channel leakage ratio.

6. An apparatus for self-testing a user equipment to determine transmit signal quality based on a feedback signal sample retrieved at output of a transmit chain, comprising:
means for correlating the feedback signal to a reference transmit signal to correct time misalignments between the transmit chain and the feedback loop, wherein the reference transmit signal is generated in digital domain at an input to a transmit chain; and
means for estimating a transmit signal quality value based on the correlation.

7. The apparatus of claim 1, wherein the means for correlating determines a feedback receiver response compensation based on feedback signal response to the reference transmit signal.

8. The apparatus of claim 2, wherein the means for correlating calculates a relative time delay between the feedback receiver and a transmitter of the transmit chain.

9. The apparatus of claim 1, wherein the transmit signal quality value comprises an error vector magnitude (EVM).

10. The apparatus of claim 1, wherein the transmit signal quality value comprises an adjacent channel leakage ratio.

11. An apparatus for wireless communication, comprising:
a memory; and
at least one processor coupled to the memory and configured to:
correlate the feedback signal to a reference transmit signal to correct time misalignments between the transmit chain and the feedback loop, wherein the reference transmit signal is generated in digital domain at an input to a transmit chain; and
estimate a transmit signal quality value based on the correlation.

12. The apparatus of claim 11, wherein the processor is further configured to determine a feedback receiver response compensation based on feedback signal response to the reference transmit signal.

13. The apparatus of claim 12, wherein the processor is further configured to calculate a relative time delay between the feedback receiver and a transmitter of the transmit chain.

14. The apparatus of claim 11, wherein the transmit signal quality value comprises an error vector magnitude (EVM).

15. The apparatus of claim 11, wherein the transmit signal quality value comprises an adjacent channel leakage ratio.

16. A computer program product, comprising:
a computer-readable medium comprising executable code for:
correlating the feedback signal to a reference transmit signal to correct time misalignments between the transmit chain and the feedback loop, wherein the reference transmit signal is generated in digital domain at an input to a transmit chain; and
estimating a transmit signal quality value based on the correlation.
